(19) United States
(12) Patent Application Publication
(10) Pub. No.: US 2011/0151201 A1
(43) Pub. Date: Jun. 23, 2011

(54) TRANSPARENT ELECTRODE FILM AND METHOD OF MANUFACTURING THE SAME

(76) Inventors: Jong Young LEE, Gyunggi-do (KR); Young Soo Oh, Gyunggi-do (KR); Young Ki Baek, Gyunggi-do (KR); Ho Joon Park, Seoul (KR); II Kweon Joung, Gyunggi-do (KR); Sang Hwa Kim, Gyunggi-do (KR); Hee Bum Lee, Gyunggi-do (KR); Kyoung Soo Chae, Gyunggi-do (KR)

(21) Appl. No.: 12/704,441

(22) Filed: Feb. 11, 2010

(30) Foreign Application Priority Data
Dec. 23, 2009 (KR) 10-2009-0129951

(51) Int. Cl. B32B 3/02; B32B 27/32; B32B 27/36; B32B 27/30; B32B 27/00; B32B 17/00; B32B 3/10; B32B 5/00; B05D 5/12

(52) U.S. Cl. 428/192; 428/523; 428/480; 428/704; 428/412; 428/426; 428/195.1; 428/336; 428/337; 427/77; 427/595; 427/569; 977/742

(57) ABSTRACT

Disclosed is a transparent electrode film for a touch screen, which includes a transparent substrate, an assistant adhesive layer formed on each of both surfaces of the transparent substrate, and a transparent conductive polymer layer formed on the assistant adhesive layer, thus obviating a need for an optically clear adhesive film and resulting in increased transmittance and superior price competitiveness. A method of manufacturing the transparent electrode film is also provided.

### CROSS REFERENCE TO RELATED APPLICATION

This application claims the benefit of Korean Patent Application No. 10-2009-0129951, filed Dec. 23, 2009, entitled “Transparent electrode film, and its preparing method”, which is hereby incorporated by reference in its entirety into this application.

### BACKGROUND OF THE INVENTION

1. Technical Field

The present invention relates to a method of manufacturing a substrate for a transparent electrode.

2. Description of the Related Art

Alongside digitization of computers, various kinds of home appliances and communications devices and rapid improvements in performance thereof, the demand for portable displays has become pressing. Thus, with the goal of obtaining such portable displays, electrode materials for displays must be transparent, must exhibit low resistance, must manifest high flexibility so as to achieve mechanical stability, and must have a coefficient of thermal expansion similar to that of a substrate so as to prevent a short circuit or a great change in sheet resistance even when the device is overheated or is at high temperature.

A conventional electrode configuration for a capacitive type touch screen having an upper electrode layer and a lower electrode layer has a structure consisting of a single electrode layer at X/Y axes and a ground layer and a three-layer structure of X-axis electrode layer/Y-axis electrode layer/ground layer.

The ground layer is provided so as to prevent noise from being generated by the capacitive type touch screen. As such, the ground layer should be conventionally adhered onto the touch screen using an optically clear adhesive (OCA) film.

Hence, when the number of layers is increased, transmittance is reduced and the product has an elevated price because of an increased amount of the materials being used.

FIG. 1 schematically shows a conductive film according to a conventional technique. As shown in FIG. 1, an indium tin oxide (ITO) layer 12 is formed on the lower surface of an upper transparent substrate 11, and an ITO layer 14 is formed on the upper surface of a lower transparent substrate 13.

Also, an OCA layer 15 is interposed between the upper transparent substrate and the lower transparent substrate so that the upper and lower transparent substrates are adhered to each other.

However, the major problem of the above configuration is that the formation of the conductive ITO layer as a ground layer requires OCA adhesion.

As the number of constituent layers is increased, transmittance is reduced and there is an increase in the thickness and price of products. In the conventional technique, the OCA film should be used to adhere the conductive ITO layer to the transparent substrate, undesirably increasing the number of constituent layers. Moreover, when the number of constituent layers is increased in this way, flexibility of the product becomes deteriorated.

### SUMMARY OF THE INVENTION

Accordingly, the present invention has been made keeping in mind the problems encountered in the related art and the present invention is intended to provide a conductive film in which an electrode layer is formed on each of both surfaces of a transparent substrate without the use of an adhesive film.

Also the prevent invention is intended to provide a method of manufacturing the conductive film in which an electrode layer is formed on each of both surfaces of a transparent substrate without the use of an adhesive film.

An aspect of the present invention provides a transparent electrode film for a touch screen, including a transparent substrate, an assistant adhesive layer formed on each of both surfaces of the transparent substrate, and a transparent conductive polymer layer formed on the assistant adhesive layer.

In this aspect, the assistant adhesive layer may be formed by subjecting both surfaces of the transparent substrate to UV irradiation, corona treatment, or primer treatment.

In this aspect, the conductive polymer layer may be formed using a printing process.

In this aspect, the conductive polymer layer may be made of poly-3,4-ethylenedioxythiophene/polystyrenesulfonate (PEDOT/PSS).

In this aspect, the conductive polymer layer may have a thickness of 0.001˜10 μm.

In this aspect, the transparent substrate may be made of one or more selected from the group consisting of polyethylene terephthalate, polyethylene naphthalate, polyethersulfone, glass, reinforced glass, polycarbonate, cyclic olefin copolymer, polymethylmethacrylate, mixtures thereof and laminating sheets thereof.

In this aspect, the transparent substrate may have a thickness of 10˜3000 μm.

In this aspect, the transparent electrode film as set forth in claim 1 may further include a silver electrode layer formed on the edge of the transparent electrode film.

As such, the silver electrode layer may be formed using a printing process.

Another aspect of the present invention provides a method of manufacturing the transparent electrode film for a touch screen, including providing a transparent substrate, forming an assistant adhesive layer on each of both surfaces of the transparent substrate, and forming a transparent conductive polymer layer on the assistant adhesive layer.

In this aspect, forming the assistant adhesive layer on each of both surfaces of the transparent substrate may be performed using UV irradiation, corona treatment, or primer treatment.

In this aspect, forming the transparent conductive polymer layer on the assistant adhesive layer may be performed using a printing process.

In this aspect, the conductive polymer layer may be made of poly-3,4-ethylenedioxythiophene/polystyrenesulfonate (PEDOT/PSS).

In this aspect, in forming the transparent conductive polymer layer on the assistant adhesive layer, the conductive polymer layer may be formed to have a thickness of 0.001˜10 μm.

In this aspect, the transparent substrate may be made of one or more selected from the group consisting of polyethylene terephthalate, polyethylene naphthalate, polyethersulfone, glass, reinforced glass, polycarbonate, cyclic olefin copolymer, polymethylmethacrylate, mixtures thereof and laminating sheets thereof.

In this aspect, the transparent substrate may have a thickness of 10˜3000 μm.

In this aspect, the method may further include forming a silver electrode layer during or after forming the conductive polymer layer.

As such, forming the silver electrode layer may be performed using a printing process.

### BRIEF DESCRIPTION OF THE DRAWINGS

The features and advantages of the present invention will be more clearly understood from the following detailed description taken in conjunction with the accompanying drawings, in which:

FIG. 1 schematically shows a transparent conductive film according to a conventional technique;

FIG. 2 schematically shows a transparent conductive film according to the present invention; and

FIG. 3 schematically and sequentially shows a process of manufacturing the transparent conductive film according to the present invention.

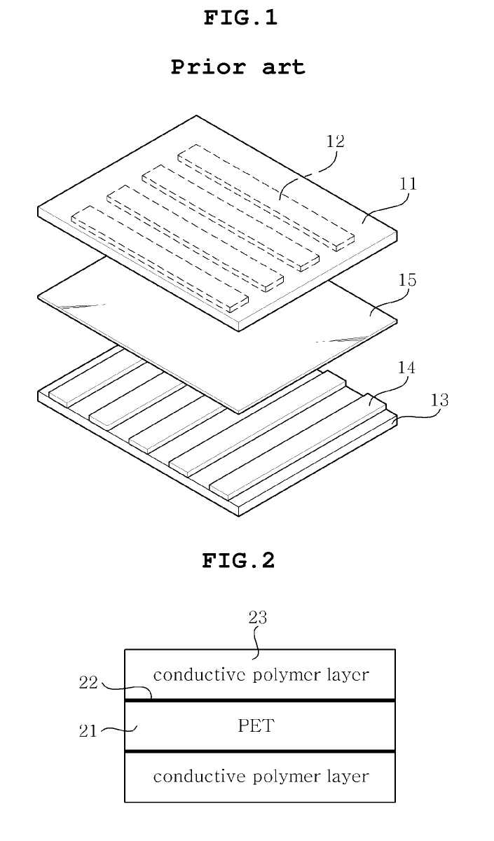

### DESCRIPTION OF SPECIFIC EMBODIMENTS

Hereinafter, embodiments of the present invention will be described in detail while referring to the accompanying drawings. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

According to an embodiment of the present invention, a transparent electrode film for a touch screen includes a transparent substrate, an assistant adhesive layer formed on each of both surfaces of the transparent substrate, and a transparent conductive polymer layer formed on the assistant adhesive layer.

The conventional technique mainly discloses a three-layer structure of X-axis electrode layer/Y-axis electrode layer/ground layer in which a transparent substrate having a conductive pattern (using ITO) formed only on one surface thereof is adhered to another transparent substrate having a conductive pattern (using ITO) formed only on one surface thereof using an OCA film.

However, according to the present invention, the transparent electrode film includes a conductive polymer layer formed on each of both surfaces of the transparent substrate, without the use of an OCA film. In the present invention, because the use of the additional adhesive layer such as the OCA film is unnecessary, the resulting transparent electrode film can have high transmittance and superior price competitiveness.

Also, a typical case where a conductive layer is formed on a transparent substrate requires the use of a hard coating layer for preventing warping of the transparent substrate, but in the present invention the need for the hard coating layer is not present thanks to the use of the conductive polymer.

FIG. 2 schematically shows the transparent conductive film according to the present invention.

In order to enhance the force of adhesion, an assistant adhesive layer 22 is formed on each of both surfaces of the transparent substrate 21 using UV irradiation, corona treatment or primer treatment, and a conductive polymer layer 23 is formed on the assistant adhesive layer 22.

The entire configuration of the transparent conductive film according to the present invention is simple because the conductive polymer layer is formed on each of both surfaces of the transparent substrate without the use of an OCA film, resulting in increased transmittance and superior price competitiveness.

In the present invention, the assistant adhesive layer formed on each of both surfaces of the transparent substrate is not an additional layer but is formed by subjecting the surface of the transparent substrate to UV irradiation, corona treatment or primer treatment so as to enable more effective adhesion of the conductive polymer layer.

The conductive polymer layer may be formed using a printing process, and examples of the printing process may include gravure printing, screen printing, offset printing, inkjet printing, etc. To this end, a conductive adhesive may be prepared by mixing a transparent adhesive with one or more selected from among conductive polymers (e.g. poly-3,4-ethylenedioxythiophene/polystyrenesulfonate (PEDOT/PSS), available from Bayer, AGFA), polyaniline, carbon nanotubes (CNTs), Graphene, nano-Ag or Cu metal, indium tin oxide (ITO), and antimony tin oxide (ATO), and may be used at a viscosity adapted for the corresponding printing process.

In particular, the conductive polymer layer may be made of PEDOT/PSS for low sheet resistance, but the present invention is not limited thereto.

The thickness of the transparent conductive polymer layer is set to 0.001˜10 μm, particularly favored being 0.05˜5 μm. If the thickness of the transparent conductive polymer layer is less than 0.001 μm, the functioning thereof as a conductive layer is insignificant, and insufficient conductive properties may be manifested. In contrast, if the thickness thereof exceeds 10 μm, the total transmittance may be reduced attributed to the excessive electrode layer thickness.

In the transparent conductive film according to the present invention, the transparent substrate may be made of one or more selected from among polyethylene terephthalate (PET), polyethylene naphthalate (PEN), polyethersulfone (PES), glass, reinforced glass, polycarbonate (PC), cyclic olefin copolymer (COC), polymethylmethacrylate (PMMA), mixtures thereof, and laminating sheets thereof, but the present invention is not limited thereto.

The transparent substrate may have a thickness of 10˜3000 μm, particularly favored being 20˜1500 μm. If the thickness of the transparent substrate is less than 10 μm, the transparent substrate insufficiently carries out the function of supporting the electrode layer. In contrast, if the thickness thereof exceeds 3000 μm, the total thickness of the film is increased, undesirably reducing transmittance and flexibility and increasing the manufacturing cost.

Also, the transparent electrode film according to the present invention may further include a silver (Ag) electrode layer formed at the edge thereof. The Ag electrode layer may be formed using an Ag paste or organic Ag, but the present invention is not limited thereto. Alternatively, a conductive polymer material, carbon black (including CNTs), a metal oxide such as ITO, or a metal may be used.

According to a specific embodiment, the Ag electrode layer may be formed by a printing process.

In addition, a method of manufacturing the conductive polymer film for a touch screen according to the present invention includes providing a transparent substrate, forming an assistant adhesive layer on each of both surfaces of the transparent substrate, and forming a transparent conductive polymer layer on the assistant adhesive layer.

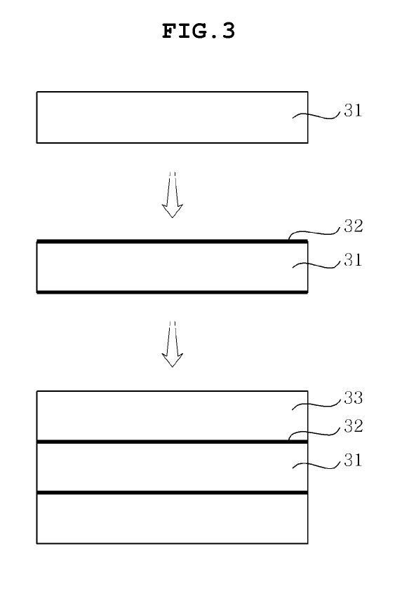

FIG. 3 schematically and sequentially shows the process of manufacturing the conductive polymer film according to the present invention.

Specifically, a transparent substrate 31 is prepared, after which both surfaces of the transparent substrate 31 are subjected to UV irradiation, corona treatment, or primer treatment.

An assistant adhesive layer 32 formed by UV irradiation, corona treatment, or primer treatment may enhance the force of adhesion of the transparent substrate 31 to a conductive polymer layer which will be formed in a subsequent procedure.

Subsequently, a conductive polymer layer 33 is formed using a printing process on each of both surfaces of the transparent substrate which was subjected to UV irradiation, corona treatment or primer treatment, thereby completing the manufacture of the transparent conductive film according to the present invention.

Below, the method of manufacturing the transparent conductive film according to the present invention is specified.

The transparent substrate is prepared using one or more selected from among PET, PEN, PES, glass, reinforced glass, PC, COC, PMMA, mixtures thereof and laminating sheets thereof. The transparent substrate may have a thickness of 10˜3000 μm, particularly favored being 20˜1500 μm. If the thickness of the transparent substrate is less than 10 μm, the transparent substrate insufficiently carries out the function of supporting the electrode layer. In contrast, if the thickness thereof exceeds 3000 μm, the total thickness of the film is increased, undesirably reducing transmittance and flexibility and increasing the manufacturing cost.

Both surfaces of the transparent substrate are subjected to UV irradiation, corona treatment or primer treatment, and thus adhesiveness thereof to the conductive material may be enhanced.

The conductive polymer layer is formed on each of both surfaces of the transparent substrate which was subjected to UV irradiation, corona treatment or primer treatment. As such, a printing process may be utilized. Examples of the printing process may include gravure printing, screen printing, offset printing, and inkjet printing.

The conductive polymer layer may be made of PEDOT/PSS and may have a thickness of 0.001˜10 μm.

For example, in the case where a gravure printing process is performed, while a transparent substrate sheet passes through between two rollers, both surfaces thereof may be coated with a conductive polymer layer. Alternatively, a conductive polymer may be applied on one surface of the transparent substrate, and then a conductive polymer may also be applied on the other surface of the transparent substrate.

The Ag electrode layer may be further formed on the conductive film during or after the formation of the conductive polymer layer.

The Ag electrode layer may also be formed by a printing process, for example continuous gravure printing or continuous/batch screen printing.

As described hereinbefore, the present invention provides a transparent electrode film and a method of manufacturing the same. Unlike a conventional technique essentially requiring an adhering process using an OCA film to form a ground terminal, according to the present invention, the transparent electrode film needs no OCA film, thus exhibiting high transmittance and superior price competitiveness.

Also, unlike the conventional technique performing an Ag electrode forming process including the etching of the corresponding portion and the printing of Ag, according to the present invention, an Ag electrode layer can be formed using direct printing during or after the formation of a conductive polymer layer, thereby reducing the manufacturing cost.

Although the embodiments of the present invention regarding the transparent electrode film for a touch screen and the method of manufacturing the same have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A transparent electrode film for a touch screen, comprising:
a transparent substrate;
an assistant adhesive layer formed on each of both surfaces of the transparent substrate; and
a transparent conductive polymer layer formed on the assistant adhesive layer.

2. The transparent electrode film as set forth in claim 1, wherein the assistant adhesive layer is formed by subjecting both surfaces of the transparent substrate to UV irradiation, corona treatment, or primer treatment.

3. The transparent electrode film as set forth in claim 1, wherein the conductive polymer layer is formed using a printing process.

4. The transparent electrode film as set forth in claim 1, wherein the conductive polymer layer comprises poly-3,4-ethylenedioxythiophene/polystyrenesulfonate.

5. The transparent electrode film as set forth in claim 1, wherein the conductive polymer layer has a thickness of 0.001˜10 μm.

6. The transparent electrode film as set forth in claim 1, wherein the transparent substrate comprises one or more selected from the group consisting of polyethylene terephthalate, polyethylene naphthalate, polyethersulfone, glass, reinforced glass, polycarbonate, cyclic olefin copolymer, polymethylmethacrylate, mixtures thereof and laminating sheets thereof.

7. The transparent electrode film as set forth in claim 1, wherein the transparent substrate has a thickness of 10˜3000 μm.

8. The transparent electrode film as set forth in claim 1, further comprising a silver electrode layer formed on an edge of the transparent electrode film.

9. The transparent electrode film as set forth in claim 8, wherein the silver electrode layer is formed using a printing process.

10. A method of manufacturing a transparent electrode film for a touch screen, comprising:
(A) providing a transparent substrate;
(B) forming an assistant adhesive layer on each of both surfaces of the transparent substrate; and
(C) forming a transparent conductive polymer layer on the assistant adhesive layer.

11. The method as set forth in claim 10, wherein (B) is performed using UV irradiation, corona treatment, or primer treatment.

12. The method as set forth in claim 10, wherein (C) is performed using a printing process.

13. The method as set forth in claim 10, wherein the conductive polymer layer comprises poly-3,4-ethylenedioxythiophene/polystyrenesulfonate.

14. The method as set forth in claim 10, wherein in (C) the conductive polymer layer is formed to have a thickness of 0.001˜10 μm.

15. The method as set forth in claim 10, wherein the transparent substrate comprises one or more selected from the group consisting of polyethylene terephthalate, polyethylene naphthalate, polyethersulfone, glass, reinforced glass, polycarbonate, cyclic olefin copolymer, polymethylmethacrylate, mixtures thereof and laminating sheets thereof.

16. The method as set forth in claim 10, wherein the transparent substrate has a to thickness of 10˜3000 μm.

17. The method as set forth in claim 10, further comprising (D) forming a silver electrode layer during or after forming the conductive polymer layer.

18. The method as set forth in claim 17, wherein (D) is performed using a printing process.
